(19) United States
(12) Patent Application Publication
(10) Pub. No.: US 2014/0076562 A1
(43) Pub. Date: Mar. 20, 2014

(54) Method of Reducing Water or Gas Permeability in a Subterranean Formation

(71) Applicants: Sumit Bhaduri, Sugar Land, TX (US); Qi Qu, Spring, TX (US)

(72) Inventors: Sumit Bhaduri, Sugar Land, TX (US); Qi Qu, Spring, TX (US)

(21) Appl. No.: 13/618,893

(22) Filed: Sep. 14, 2012

(51) Int. Cl. C09K 8/42

(52) U.S. Cl. CPC C09K 8/426
USPC 166/295

(57) ABSTRACT

Water and gas flow into a subterranean reservoir may be reduced by pumping into the reservoir a primary amine crosslinking agent and an anionic or hydrolyzable nonionic polymer capable of crosslinking with the crosslinking agent. The reaction product forms a gel plug impermeable to water and gas.

### FIELD OF THE INVENTION

Water and gas flow through a high permeability channel in a subterranean reservoir is reduced by pumping into the reservoir a system comprising a primary amine crosslinking agent, such as a polyallylamine or salt thereof, and an anionic or hydrolyzable nonionic polymer.

### BACKGROUND OF THE INVENTION

Excessive water production during the treatment of a porous subterranean formation penetrated by a well causes fluid loss to highly permeable zones in the formation. Such zones are often called thief zones. The amount of oil and/or gas that may be ultimately recovered from the well is decreased since the water takes the place of other fluids that may flow or be lifted from the well. Thus, excessive water production has a direct affect on the productivity of the well and increases operating expenditures. In addition, expenditures are increased due to the need for disposal of produced water in an environmentally safe manner.

In the past, gel systems have been used to control water production and reduce the flow of produced water though high permeability channels within the formation. Such gellants plug pore spaces of the formation and prevent fluid movement, often by means of a controlled, delayed chemical reaction, such as precipitation or swelling.

For instance, success has been reported with three-dimensional crosslinked polymer gel systems. Such systems include a base polymer and a crosslinking agent, both of which may be liquid concentrates in water. Depending on formation temperatures, varying ratios and concentrations of the base polymer and crosslinking agent are mixed in water and then pumped into the formation. The reaction between the base polymer and the crosslinking agent creates a strong gel barrier which shuts off or reduces water production.

Water-soluble polyacrylamides have been commonly used as the base polymer. Crosslinking agents which have used with the base polymer include chromium (+3). The crosslinking reaction occurs by complexation of the Cr ions with the carboxylate groups on the polymer chains. Successful treatments in fractured formations, however, often require relatively large volumes (e.g., 10,000 to 37,000 bbl/well) of gel. Further, such systems have been shown to be unsuitable for in-depth radial placement into reservoir formations because of their short gel times. Limited propagation into targeted pore spaces of such systems has also been observed.

Polyethyleneimines, polyalkylenepolyamines and mixtures thereof have also been used in lieu of chromium crosslinking agents. The polyalkyenepolyamines are typically the polymeric condensates of lower molecular weight polyalkylenepolyamines and a vicinal dihaloalkane. Polyalkyleneimines include polymerized ethlenimine and propylenimine. However, such products are corrosive and are typically unacceptable for use in sensitive areas. In addition, polyacrylamide systems containing such crosslinking agents exhibit undesirably long gel times at low temperatures unless very high concentrations of polymer and crosslinking agent are used. Thus, such systems have been shown to be unacceptable at low temperatures, for example at or below 140° F.

Chitosan has also been reported for use as a crosslinking agent. However, the usefulness of chitosan has been limited by its relative poor solubility in aqueous solutions. For example, since chitosan is only sparingly soluble in water, in order to main an acceptable viscosity, the highest concentration of chitosan can only be about 1 to 2 percent in the treatment fluid. Further, fluids containing chitosan as crosslinking agent exhibit poor degradability since the majority of the fluid is the non-biodegradable polyacrylamide.

Alternative crosslinking agents for use with polyacrylamides have therefore been sought.

### SUMMARY OF THE INVENTION

The invention relates to a method of minimizing fluid loss to porous underground formations by pumping into the formation a primary amine crosslinking agent or a salt thereof and a viscosifying agent of an anionic or hydrolyzable nonionic polymer and forming a fluid impermeable reaction product from the viscosifying agent and primary amine crosslinking agent or salt thereof.

In an embodiment, a method is provided for reducing the permeability of a porous subterranean formation by pumping into the formation a primary amine crosslinking agent or salt thereof and an anionic or hydrolyzable nonionic polymer capable of crosslinking with the primary amine crosslinking agent or salt thereof.

In another embodiment, a method is provided for reducing the permeability of a subterranean formation by first pumping into the formation a primary amine crosslinking agent or salt thereof; and then pumping water into the formation followed by the pumping of an anionic or hydrolyzable nonionic polymer capable of crosslinking with the primary amine crosslinking agent or salt thereof. Additional water may then be pumped into the formation followed by the further addition of primary amine crosslinking agent. A fluid impermeable plug is formed in the formation from the gelled reaction product of the primary amine crosslinking agent and the anionic or hydrolyzable nonionic polymer.

In another embodiment, a method is provided for reducing fluid loss to a porous subterranean formation by pumping into the wellbore penetrating the formation a primary amine crosslinking agent or salt thereof and an anionic or hydrolyzable nonionic polymer capable of crosslinking with the primary amine crosslinking agent or salt thereof. The reaction product of the primary amine crosslinking agent and the viscosifying agent is gelled in the formation to form a fluid impermeable plug.

In another embodiment, a method is provided for reducing flow into a porous thief zone penetrated by a water injection wellbore by pumping into the wellbore and into the porous thief zone a primary amine crosslinking agent or salt thereof and a viscosifying agent of an anionic or hydrolyzable nonionic polymer capable of crosslinking with the primary amine crosslinking agent or salt thereof. A fluid impermeable plug is formed from the reaction product of the viscosifying agent and the crosslinking agent in the porous thief zone.

In one embodiment, the anionic or hydrolyzable nonionic polymer is selected from the group consisting of polyacrylamides, alkyl polyacrylamides, copolymers of polyacrylamide and alkylpolyacrylamides with ethylene, propylene and styrene, polymaleic anhydride and polymethacrylate and hydrolysis products thereof.

In an embodiment, the primary amine crosslinking agent is a polyallylamine, polyvinylamine, polyamidoamine, polyalkyl amine or a polyarylamine.

The primary amine crosslinking agent and viscosifying agent may be pumped into the wellbore as a fluid or as a powder.

The primary amine crosslinking agent and viscosifying agent may be pumped separately into the wellbore.

### DETAILED DESCRIPTION OF THE PREFERRED EMBODIMENTS

Fluid loss to porous underground formations is minimized by pumping into the wellbore penetrating the formation a primary amine crosslinking agent and a viscosifying agent of an anionic or hydrolyzable nonionic polymer capable of crosslinking with the primary amine crosslinking agent. A salt of the primary amine crosslinking agent may also be used. Permeability of the porous formation is reduced by formation of the gelled reaction product of the primary amine crosslinking agent or salt thereof and viscosifying agent.

Any anionic polymer (or nonionic polymer which is hydrolyzable to the anionic polymer) capable of reacting with and crosslinking the crosslinking agent may be used as viscosifying agent. In order to be capable of being hydrolyzed to provide reactive groups for crosslinking and gelling the viscosifying agent, the nonionic polymer needs only to be contacted with water to effect immediate hydrolysis. Nonionic polymer requiring an extended period of contact and/or heating or agitation in order to affect hydrolysis in a reasonable period of time may also be used. The water necessary for hydrolysis of the nonionic polymer may be ordinarily found within the formation being treated.

Suitable viscosifying agents are polyacrylamide and alkylpolyacrylamides, copolymers of polyacrylamide and alkylpolyacrylamides (such as copolymers with ethylene, propylene and/or styrene), polymaleic anhydride, polyacrylate and polymethacrylate and mixtures thereof and salts thereof. For instance, the viscosifying agent may be a copolymer of sodium acrylate and acrylamide. Further, suitable viscosifying agents are set forth in U.S. Pat. No. 4,773,481, herein incorporated by reference.

When hydrolyzed, the viscosifying agent preferably has free carboxylate groups for reaction with the pendant primary amine moieties of the crosslinking agent. The functional primary amine groups of the crosslinking agent react with the carboxylate groups of the viscosifying agent. The viscosifying agent is at least partially hydrolyzed in order to provide the reactive carboxylate groups. As defined herein, partially hydrolyzed refers to at least 1%, but not 100%, of the functional groups of the viscosifying agent in the form of carboxylate groups.

The viscosifying agent may be hydrolyzed prior to being pumped into the subterranean formation. In such cases, the partially hydrolyzed viscosifying agent and crosslinking agent are pumped separately into the formation.

In a preferred embodiment, the viscosifying agent is partially hydrolyzed polyacrylamide (PHPA). As such, the partially hydrolyzed polyacrylamide (PHPA) is an acrylamide containing polymer having at least 1%, but not 100%, of the acrylamide groups in the form of carboxylate groups.

Further suitable viscosifying agents include copolymers containing acrylamide and at least one of an acrylate and an acrylamidomethylpropane sulfonic acid (AMPS). Such viscosifying agents include those copolymers are of the formula:

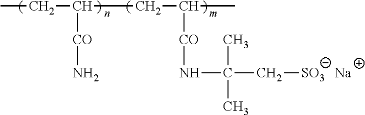

wherein m is 2 to 5 and n is 4 to 8. Exemplary of such viscosifying agents are containing from about 20 to 50% acrylamidomethylpropane sulfonic acid (AMPS), about 2 to 5% acrylic acid, and about 45 to 78% acrylamide. More preferably, the polymer comprises about 35 to 50% AMPS.

The weight average molecular weight of the polyacrylamide pertaining to the invention is between from about 0.1 MMDa to about 30 MMDa, preferably between from about 0.25 MMDa to about 10 MMDa.

The crosslinking agent contains preferentially free primary amines, and has no presence of any secondary, tertiary or quaternized amines. Such crosslinking agents are more environmentally friendly than those used in the systems of the prior art.

The weight average molecular weight of the primary amine crosslinking agent is generally between from about 5,000 to about 150,000, preferably from about 15,000 to about 50,000.

Suitable primary amine crosslinking agents include polyallylamines, polyvinylamines, polyamidoamines, polyalkylamines and polyarylamines.

In a preferred embodiment, the primary amine is a polyallylamine of the formula:

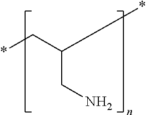

or a salt thereof, wherein n is from about 100 to about 3,000, preferably from about 250 to about 1,000. Suitable anions of the salt include halides. In one embodiment the polyallylamine is a hydrogen chloride salt of the above formula.

In a most preferred embodiment, the primary amine is a diallyl amine or a polyallylamine hydrochloride (PAH) homopolymer and copolymer, optionally comprising modifier units.

Further, the primary amine may be formed via ring-forming polymerization of N,N-diallyl-N,N-di(C₁-C₄ alkyl)ammonium halide, comprising units of the formula:

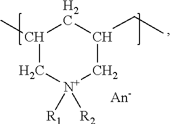

wherein R₁ and R₂ are each independently C₁-C₄ alkyl, in particular methyl, and An⁻ is an anion, for example, a halide anion such as the chloride anion.

The most preferred polycationic polymer is poly(diallydimethyllamine hydrochloride).

Suitable modifier units of the polyallylamine (i) are known and comprise, for example, units of formula:

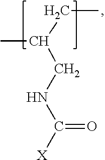

wherein X is C₁-C₆ alkyl, which is substituted by two or more of the same or different substituents selected from the group consisting of hydroxy, C₁-C₅ alkanoyloxy, and C₁-C₅ alkylaminocarbonyloxy. Preferred modifier units are hydrophilic monomers such as acrylamide, methacrylamide, N,N-dimethyl acrylamide, N-vinylpyrrolidone and the like.

Preferred substituents of the alkyl radical X are hydroxy, acetyloxy, propionyloxy, methyl-aminocarbonyloxy or ethylaminocarbonyloxy, especially hydroxy, acetyloxy or propionyloxy and in particular hydroxy. X is preferably linear C₃-C₆ alkyl, more preferably linear C₄-C₅ alkyl, and most preferably n-pentyl, which is in each case substituted as defined above. A particularly preferred radical X is 1,2,3,4,5-pentahydroxy-n-pentyl.

Suitable polyamidoamines include diallyl acrylamide, diallyl methacrylamide as well as homo- and copolymers of a quaternized di(C₁-C₄ alkyl)aminoethyl acrylate or methacrylate, for example a poly[2-hydroxy-3-methacryloylpropyltri(C₁-C₂ alkyl)ammonium salt] homopolymer, such as poly(2-hydroxy-3-methacryloylpropyltrimethylammonium chloride), or a quaternized poly(2-dimethylaminoethyl methacrylate or a quaternized poly(vinylpyrrolidone-co-2-dimethylaminoethyl methacrylate); or a polyaminoamide (PAMAM), for example a linear PAMAM or a PAMAM dendrimer.

Suitable polyvinylamines include polyvinylamine homo- and copolymers, optionally comprising a modifier unit and poly[vinylbenzyl-tri(C₁-C₄ alkyl)ammonium salts], for example poly(vinylbenzyl-trimethylammonium chloride).

Suitable polyalkylamines and polyarylamines are those having at least two amine or substituted amino groups per molecule, preferably a polyalkylene or aromatic polyamine having from 1 to about 4 secondary amine groups per molecule wherein each alkylene group contains between from about 2 to about 8 carbon atoms and the amino group is of the formula —N(R₈)(R₉) wherein each R₈ and R₉ are independently selected from —H or a C₁-C₆ alkyl or alkylene group.

Suitable polyalkylamines include polymers resulting from a step-wise polymerization (quaternization) reaction between a dihalide and N,N,N′,N′-tetra(C₁-C₄ alkyl)-alkylenediamine, for example a polymer from (a) propylene-1,3-dichloride or -dibromide or o-, m-, or p-xylylene dichloride or dibromide and (b) N,N,N′,N′-tetramethyl-1,4-tetramethylenediamine.

Further preferred are those polyalkylene polyamines of the formula R₁₀R₁₁N(R₁₂R₁₃N)_{z}R₁₄, where R₁₀, R₁₁, R₁₃, and R₁₄ are independently —H or a C₁-C₃₀ alkyl or aryl group, R₁₂ is a methylene or a C₂-C₂₄ alkylene group, and z is 0 to 1000.

The crosslinking agents described herein may be used in a liquid state (dissolved in aqueous fluids) or in a powder state. Since the viscosifying agents may also be used in a powder state, one or both of the primary amine crosslinking agent and viscosifying agent may be shipped to a remote location and may be prepared in a liquid state on site and pumped as a slurry.

Further, the primary amine crosslinking agent and the viscosifying agent may be pumped into the wellbore as separate fluids or as a single fluid.

The crosslinking agent can be used in amounts from about 0.1 percent to about 100 percent by weight of the viscosifying agent, but preferably are employed in amounts between about 5 percent and about 20 percent by weight. The well treatment fluid typically contains between about 3 percent to about 6 percent by weight of the viscosifying agent.

The reactivity of the primary amine crosslinking agent and the viscosifying agent will vary widely depending on the amounts and the particular materials used. For example, hydrolyzed polyacrylamide, even in very small quantities, crosslinks with the primary amine crosslinking agent almost immediately.

The volume of viscosifying agent and crosslinking agent injected in the zone of high permeability to be treated is determined by the size of the zone. Typically, volumes from about 5 to about 100 percent of the pore volume of the zone to be treated are used.

Once the amount of material to be injected has been determined and the injection rate has been set, the treatment time can then be estimated. If the viscosifying agent and crosslinking agent are to be injected into the formation together, they are then selected to provide a material which is stable for the amount of time equal to the required treatment time.

The viscosity of the treatment fluid may increase until the treatment fluid is very thick. For example, in some embodiments, the viscosity of the treatment fluid may increase until the treatment fluid has the properties of a rigid ringing gel. As used herein, the term “ringing gel” refers to a gel that, when formed in a container, vibrates audibly when the side of the container is struck. Depending on the concentration and temperature of the gelled fluid, a ringing gel may form at 150° F. in time ranging from 5 hours to 18 hours.

The systems defined herein may further be used in conjunction with a retarder, such as an aluminum salt.

The fluid described herein is highly effective in plugging an isolated high-permeability zone or fracture at the wellbore face at considerable depth to prevent flood water from otherwise merely flowing around the plug and back into the high-permeability or swept zone. In depth plugging of a relatively high-permeability or thief zone converts the zone into a much lower permeability zone. Subsequently injected flood water or other fluid enters the formerly by-passed, but now relatively more permeable hydrocarbon-bearing zone, and thus mobilizes increased amounts of hydrocarbons from the formation. Thus, permeability of a highly permeable zone in a subterranean formation is reduced by introducing into the formation the system described herein since the crosslinking agent is capable of crosslinking with and gelling the viscosifying agent to form the fluid impermeable barrier. This procedure is preferably followed in those instances where the reactivity of the materials used in carrying out the invention is such that they cannot be combined outside the formation to be treated without premature crosslinking. This is often the case when anionic polymers are used as the viscosifying agent.

In an embodiment, the primary amine crosslinking agent may be introduced into the well, preferably packed in order to isolate the permeable zone, and pumped into the formation. The crosslinking agent may be adsorbed onto the formation rock. Water flood water (usually formation water) may then be injected into the formation in a similar manner in order to clean the wellbore and the adjacent formation of the primary amine crosslinking agent to prevent premature gelling in locations upon introduction of the viscosifying agent. The viscosifying agent, capable of crosslinking with and gelling the primary amine crosslinking agent may then be injected into the formation in a corresponding manner. The viscosifying agent reacts with the adsorbed primary amine crosslinking agent and may leave additional reactive groups open for further reaction. A second water injection may then be carried out. Finally, additional primary amine crosslinking agent may then be injected which reacts with the open reactive groups of the viscosifying agent in the formation to form a crosslinked gel system. If desired, the method can be repeated to obtain a desired degree of permeability reduction. In a water flood operation where the zone has previously passed a major portion of the fluids injected into the formation, these fluids are now forced into other zones which contain oil thereby increasing the production of oil from the formation.

The system may be used in shutting off water production at formation temperatures ranging from ambient to in excess of 400° F. In an embodiment, the system may be used in shutting off fluids in shallow water/gas zones. In such instances, the systems are capable of providing gel times and strengths at temperatures less than 80° F. and as well as at temperatures as low as 40° F. to 50° F.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

### EXAMPLES

About 0.55 cc of a 10 weight percent solution of poly-allylamine in tap water was mixed with about 100 cc of a 5 weight percent solution of polyacrylamide of molecular weight of about 500,000 in deionized water at room temperature. The mixture was left in a water bath of about 150° F. for about 15 hours to render a viscous gel. The viscosity of the gel was in excess of 100,000 cP at room temperature. The high viscosity of the gel indicates that the gel is impermeable to water and gas. The temperature stability of the formed gel was monitored and found to be stable for greater than 6 months from about 80° F. to about 350° F.

From the foregoing, it will be observed that numerous variations and modifications may be effected without departing from the true spirit and scope of the novel concepts of the invention.

What is claimed is:

1. A method for reducing the permeability of a subterranean formation penetrated by a wellbore which comprises pumping into the formation through the wellbore:
(a) a primary amine crosslinking agent or a salt thereof, wherein the primary amine crosslinking agent is selected from the group consisting of polyallylamines, polyvinylamines, polyamidoamines, polyalkyl amines and polyarylamines; and mixtures thereof;
(b) an anionic or hydrolyzable nonionic polymer capable of crosslinking with the primary amine crosslinking agent or salt thereof, wherein the anionic or hydrolyzable nonionic polymer is selected from the group consisting of polyacrylamides; alkyl polyacrylamides; copolymers of polyacrylamide and/or alkylpolyacrylamides with ethylene, propylene and/or styrene; polymaleic anhydride; and polymethacrylate; and hydrolysis products thereof; and mixtures thereof; and
forming a fluid impermeable plug in the formation from the gelled reaction product of the primary amine crosslinking agent and anionic or hydrolyzable nonionic polymer.

2. The method of claim 1, wherein the anionic or hydrolyzable nonionic polymer and primary amine crosslinking agent are pumped into the wellbore as dry powders.

3. The method of claim 1, wherein the primary amine crosslinking agent is selected from the group consisting of polyallylamines, polyvinylamines, polyamidoamines, polyalkyl amines, and polyarylamines, and mixtures thereof.

4. The method of claim 1, wherein the viscosifying agent and primary amine crosslinking agent are pumped into the wellbore in an aqueous fluid.

5. The method of claim 1, wherein the viscosifying agent and primary amine crosslinking agent are pumped into the wellbore in separate stages.

6. The method of claim 1, wherein at least one of the viscosifying agent and primary amine crosslinking agent are pumped into the wellbore as dry powders.

7. The method of claim 1, wherein the viscosifying agent is hydrolyzed prior to being pumped into the wellbore.

8. The method of claim 1, wherein the viscosifying agent is a partially hydrolyzed polyacrylamide.

9. The method of claim 3, wherein the primary amine crosslinking agent is a polyallylamine or a salt thereof.

10. The method of claim 9, wherein the primary amine crosslinking agent is a quaternary amine salt of a polyallylamine.

11. The method of claim 1, wherein the molecular weight of the primary amine crosslinking agent is between from about 10,000 to about 50,000.

12. The method of claim 9, wherein the polyallyamine is selected from the group consisting of (i) diallyl amines; (ii) polyallylamine hydrochloride (PAH) homopolymers; (iii) a copolymer containing PAH and a unit of the formula: 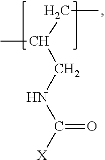
and; (iv) a polymer via ring-forming polymerization of N,N-diallyl-N,N-di(C1-C4 alkyl)ammonium halide, comprising units of the formula: 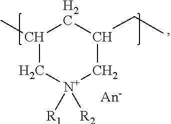
wherein:
X is a C₁-C₆ alkyl, optionally substituted by two or more of the same or different substituents selected from the group consisting of hydroxy, C₁-C₅ alkanoyloxy, and C₁-C₅ alkylaminocarbonyloxy;
R₁ and R₂ are each independently C₁-C₄ alkyl; and
An⁻ is an anion.

13. The method of claim 1, wherein the viscosifying agent is a polyvinylamine selected from the group consisting of polyvinylamine homopolymers; polyvinylamine copolymers; and poly[vinylbenzyl-tri(C₁-C₄ alkyl)ammonium salts].

14. A method for reducing flow into a porous thief zone penetrated by a water injection wellbore which comprises:
(a) pumping into the wellbore and into the porous thief zone:
(i) a viscosifying agent of an anionic or hydrolyzable non-ionic polymer selected from the group consisting of polyacrylamides; alkyl polyacrylamides; copolymers of polyacrylamide and alkylpolyacrylamides with ethylene, propylene and styrene; polymaleic anhydride; and polymethacrylate; and hydrolysis products thereof; and mixtures thereof;
(ii) a primary amine crosslinking agent or a salt thereof selected from the group consisting of polyallylamines, polyvinylamines, polyamidoamines, polyalkyl amines and polyarylamines, and mixtures thereof; and
(b) forming a fluid impermeable plug from the reaction product of the viscosifying agent and the primary amine crosslinking agent in the porous thief zone.

15. The method of claim 14, wherein the viscosifying agent and primary amine crosslinking agent are pumped into the wellbore in an aqueous fluid.

16. The method of claim 15, wherein the viscosifying agent and the primary amine crosslinking agent are pumped into the wellbore in separate stages.

17. The method of claim 14, wherein at least one of the viscosifying agent and the primary amine crosslinking agent are pumped into the wellbore as dry powders.

18. A method of reducing fluid loss to a porous subterranean formation penetrated by a wellbore comprising:
(A) pumping into the wellbore:
(a) a viscosifying agent of an anionic or hydrolyzable non-ionic polymer s selected from the group consisting of polyacrylamides; alkyl polyacrylamides; copolymers of acrylamide and/or alkylacrylamides with ethylene, propylene and/or styrene; polymaleic anhydride; and polymethacrylate; and mixtures thereof; and wherein the viscosifying polymer is either (i) at least partially hydrolyzed; or (ii) at least partially hydrolyzable after being pumped into the wellbore;
(b) a primary amine crosslinking agent or a salt thereof selected from the group consisting of polyallylamines; polyvinylamines; polyamidoamines; polyalkyl amines; and polyarylamines; and mixtures thereof
(B) gelling in the formation the reaction product of the primary amine crosslinking agent and the viscosifying agent, which is at least partially hydrolyzed; and
(C) forming a fluid impermeable plug in the formation from the reaction product
wherein the fluid impermeable plug reduces the loss of fluid to a permeable zone of the subterranean formation.

19. The method of claim 18, wherein the primary amine crosslinking agent is a salt of the polyallylamine of the formula:

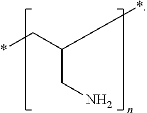

20. The method of claim 19, wherein the primary amine crosslinking agent is a HCl salt of the polyallylamine of the formula:

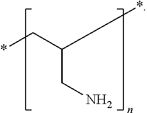

21. The method of claim 18, wherein the viscosifying agent is a partially hydrolyzed polyacrylamide.

22. The method of claim 20, wherein the viscosifying agent is a partially hydrolyzed polyacrylamide.

23. A method for reducing the permeability of a subterranean formation penetrated by a wellbore which comprises:
(a) pumping into the formation via the wellbore a primary amine crosslinking agent or a salt thereof, wherein the primary amine crosslinking agent is selected from the group consisting of polyallylamines, polyvinylamines, polyamidoamines, polyalkyl amines and polyarylamines, and mixtures thereof;
(b) pumping water into the formation,
(c) pumping into the formation an anionic or hydrolyzable nonionic polymer capable of crosslinking with the primary amine crosslinking agent or salt thereof, wherein the anionic or hydrolyzable nonionic polymer is selected from the group consisting of polyacrylamides; alkyl polyacrylamides; copolymers of polyacrylamide and alkylpolyacrylamides with ethylene, propylene and styrene; polymaleic anhydride; polymethacrylate; and hydrolysis products thereof; and mixtures thereof;
(d) pumping water into the formation,
(e) pumping into the formation a further amount of the primary amine crosslinking agent and forming a fluid impermeable plug in the formation from the gelled reaction product of the primary amine crosslinking agent and anionic or hydrolyzable nonionic polymer.

24. The method of claim 23, further comprising repeating steps (a) through (e) until a targeted reduction in permeability in the formation is attained.
